(19) United States
(12) Patent Application Publication
(10) Pub. No.: US 2021/0395516 A1
(43) Pub. Date: Dec. 23, 2021

(54) Polyglycolide Copolymer and Preparation Thereof

(71) Applicant: Pujing Chemical Industry Co., Ltd., Shanghai (CN)

(72) Inventor: Xinzhou ZHANG, Shanghai (CN)

(21) Appl. No.: 17/289,392

(22) PCT Filed: Oct. 29, 2018
(86) PCT No.: PCT/CN2018/112434

§ 371 Date: Apr. 28, 2021

(51) Int. Cl. C08L 67/04; C08G 63/82; C08J 3/12; C08J 3/20; C08G 63/08; C08G 63/78

(52) U.S. Cl. CPC C08L 67/04; C08G 63/823; C08J 3/12; C08J 3/203; C08J 2367/04; C08G 63/785; C08L 2201/08; C08L 2203/30; C08G 63/08

(57) ABSTRACT

Disclosed is a copolymer of polyglycolide and one or more additives. The copolymer may have a weight-average molecular weight (Mw) in the range of 10,000-1,000,000 and a ratio of a weight-average molecular weight to a number-average molecular weight (Mw/Mn) in the range of 1.0 to 10.0. The copolymer may have a melt index (MFR) in the range of 0.1 to 1000 g/10 min. The copolymer has good mechanical properties, thermal stability and hydrolytic stability. Also provided is a process for preparing the copolymer.

### FIELD OF THE INVENTION

The invention provides a novel degradable copolymer having good mechanical properties, thermal stability and hydrolytic stability, and preparation thereof.

### BACKGROUND OF THE INVENTION

Traditional high molecular polymers such as polypropylene, polyethylene, polyethylene terephthalate, polybutylene terephthalate, etc., have been widely accepted and used in daily life. As a substitute for metal and biomaterials, the price is superior. The mechanical properties of these materials are further strengthened by making corresponding composites, making them even more popular. However, since they are difficult to degrade naturally and inconvenient to recycle, conventional polymer materials are likely to cause severe pollution and have harmful impacts (CN107603171).

In recent years, degradable polymers have gradually gained people's attention, and polylactic acid (PLA) is one of them. It has a wide range of sources and can be used in daily necessities, packaging, medical and other fields. However, its poor mechanical properties and low heat distortion temperature limit its further use. CN107529538 discloses a modification process for pure polylactic acid materials. Although the heat resistant temperature has been improved, the mechanical and mechanical properties are still poor.

There remains a need for degradable polymers or copolymers with good mechanical properties and thermal stability.

### SUMMARY OF THE INVENTION

The present invention provides polyglycolide copolymers and preparation thereof.

A copolymer is provided. The copolymer comprises one or more repeating units of C-(Aₓ-B_{y})ₙ-D. A is

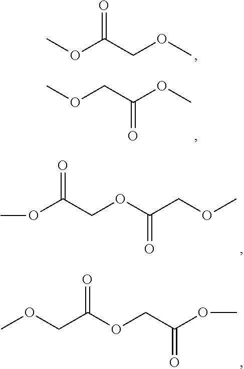

or a combination thereof. B is G-R₁—W. G and W are each selected from the group consisting of —CO—NH—, —CO—R₂—CO—OH, —CO—, —(CH₂)₂NH—CO—, —CH₂—CH(OH)—CH₂— and —NH. R₁ is an aliphatic polymer, an aromatic polymer or a combination thereof. R₂ is an alkyl group, an aromatic group, or an olefin group. x is between 1 and 1500. y is between 1 and 1500. n is between 1 and 10000. C and D are each a terminal group selected from the group consisting of a hydroxyl group, a carboxyl group, an amine group, an alkyl group, an aromatic group, an ether group, an alkene group, a halogenated hydrocarbon group and a combination thereof. A and B are different in structure.

The copolymer may further comprise an additive. The additive may be selected from the group consisting of E, F or a combination thereof.

E may be one or more of units of i-R₁-j. i and j may be each selected from the group consisting of an isocyanate group (—N═C═O), an acid chloride group, an oxazolyl group, an oxazoline group, an anhydride, an epoxy group, an amine group and a combination thereof. R₁ may be an aliphatic group, an aromatic group, or a combination thereof. F may be selected from the group consisting of an antioxidant, a metal passivator, an end capping agent, a nucleating agent, an acid scavenger, a heat stabilizer, a UV stabilizer, a lubricant plasticizer, a crosslinking agent, and a combination thereof.

A process for preparing a copolymer is provided. The process comprises ring-opening polymerizing glycolide in a molten state, whereby a polyglycolide is formed; and extruding and granulating the polyglycolide to prepare a copolymer. The copolymer comprises one or more repeating units of C-(Aₓ-B_{y})ₙ-D. A is

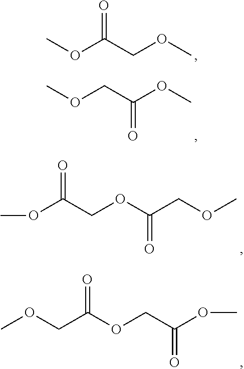

or a combination thereof. B is G-R₁—W. G and W are each selected from the group consisting of —CO—NH—, —CO—R₂—CO—OH, —CO—, —(CH₂)₂NH—CO—, —CH₂—CH(OH)—CH₂— and —NH. R₁ is an aliphatic polymer, an aromatic polymer or a combination thereof. R₂ is an alkyl group, an aromatic group, or an olefin group. x is between 1 and 1500. y is between 1 and 1500. n is between 1 and 10000. C and D are each a terminal group selected from the group consisting of a hydroxyl group, a carboxyl group, an amine group, an alkyl group, an aromatic group, an ether group, an alkene group, a halogenated hydrocarbon group, and a combination thereof. A and B are different in structure.

The polyglycolide may be extruded and granulated with an additive selected from the group consisting of E, F or a combination thereof. E may be one or more of units of i-R₁-j. i and j may be each selected from the group consisting of an isocyanate group (—N═C═O), an acid chloride group, an oxazolyl group, an oxazoline group, an anhydride, an epoxy group, an amine group and a combination thereof. R₁ may be an aliphatic group, an aromatic group, or a combination thereof. F is selected from the group consisting of an antioxidant, a metal passivator, an end capping agent, a nucleating agent, an acid scavenger, a heat stabilizer, a UV stabilizer, a lubricant plasticizer, a crosslinking agent, and a combination thereof.

The process may further comprise feeding the polyglycolide into an extruder, and adding the E and the F into the extruder.

The ring-opening polymerization of glycolide may be a three-stage reaction, comprising: (a) reacting the glycolide with a ring-opening polymerization catalyst at 80-160° C. for no more than 120 minutes, wherein a first mixture is formed; (b) maintaining the first mixture at 120-280° C. for a time from 1 minute to 72 hours, whereby a second mixture is formed; (c) maintaining the second mixture at 160-280° C. and an absolute pressure no more than 5000 Pa for a time from 1 minute to 24 hours. As a result, the polyglycolide is formed. Step (a) may further comprise mixing the glycolide with the ring-opening polymerization catalyst uniformly. Step (a) may be carried out in a reactor. Step (b) may be carried out in a plug flow reactor. The plug flow reactor may be selected from the group consisting of a static mixer, a twin-screw unit, and a horizontal disk reactor. Step (c) may be carried out in a devolatilization reactor. Step (b) may be carried out in a twin-screw extruder at 200-300° C.

The ring-opening polymerization catalyst may be a metal catalyst or a non-metal catalyst. The catalyst may be selected from the group consisting of a rare earth element, a rare earth element oxide, a metal magnesium compound, an alkali metal chelate compound (e.g., tin, antimony, or titanium), a metal ruthenium, and a combination thereof. The catalyst may be 0.01-5 wt % of the glycolide.

A copolymer prepared according to the process of the present invention is provided.

The copolymer of the present invention may comprise an additive at 0.01-5 wt %, based on the total weight of the copolymer. The additive may be selected from the group consisting of E, F or a combination thereof.

The copolymer may have a weight-average molecular weight of 10,000-1,000,000. The copolymer may have a ratio of a weight-average molecular weight to a number-average molecular weight (Mw/Mn) at 1-10.

The copolymer may have a melt index (MFR) of 0.1-1000 g/10 min. The MFR may be determined according to a method comprising: (a) drying the copolymer under vacuum at 100-110° C.; (b) packing the dried copolymer from step (a) into a rod; (c) keeping the rod at 220-240° C. for 0.5-1.5 minutes; (d) cutting a segment from the rod every 15-45 seconds after step (c); and (e) determining a MFR of each segment based on MFR=600 W/t (g/10 min). W is the average mass of each segment and t is the cutting time gap for each segment. Step (b) may further comprise loading 3-5 g of the dried copolymer into a barrel, inserting a plunger into the barrel to compact the dried copolymer into the rod, and placing a weight of 2-3 kg on the top of the plunger.

At least 66 wt % of the copolymer may remain at 65° C. after 7 days.

### DETAILED DESCRIPTION OF THE INVENTION

The invention provides novel degradable material polyglycolide copolymers and preparation thereof. This invention is based on the inventors' surprising discovery of a novel process for preparing polyglycolide copolymers with one or more additives to improve their thermal stability, hydrolytic stability, and mechanical properties. The polyglycolide copolymers of the present invention are suitable for diverse uses, for example, fibers, downhole tools, packaging, film, drug carriers, abrasives, medical implants, and underwater antifouling materials, etc.

The terms “polyglycolide,” “poly(glycolic acid) (PGA)” and “polyglycolic acid” are used herein interchangeably and refer to a biodegradable, thermoplastic polymer composed of monomer glycolic acid. A polyglycolide may be prepared from glycolic acid by polycondensation or glycolide by ring-opening polymerization. An additive may be added to the polyglycolide to achieve a desirable property.

The term “polyglycolide copolymer” is a polymer derived from a glycolide or glycolic acid monomer and a different polymer monomer. For example, a polyglycolide copolymer may be prepared with a polyglycolide and ADR4368 (a commercial epoxy polymer of styrene and acrylic acid from BASF) by extrusion,

A copolymer is provided. The copolymer comprises one or more repeating units of C-(Aₓ-B_{y})ₙ-D. A is selected from the group consisting of

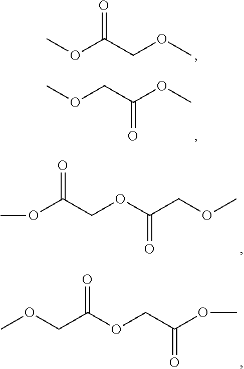

and a combination thereof. B is G-R₁—W, in which G and W are each selected from the group consisting of —CO—NH—, —CO—R₂—CO—OH, —CO—, —(CH₂)₂NH—CO—, —CH₂—CH(OH)—CH₂— and —NH; R₁ is an aliphatic polymer, an aromatic polymer or a combination thereof; and R₂ is an alkyl group, an aromatic group, or an olefin group. x is between 1 and 1500. y is between 1 and 1500. n is between 1 and 10000. C and D are each a terminal group selected from the group consisting of a hydroxyl group, a carboxyl group, an amine group, an alkyl group, an aromatic group, an ether group, an alkene group, a halogenated hydrocarbon group and a combination thereof. A and B are different in structure.

The copolymer may further comprise E. E may be one or more of units of i-R₁-j. i and j are each selected from the group consisting of an isocyanate group (—N═C═O), an acid chloride group, an oxazolyl group, an oxazoline group, an anhydride, an epoxy group, an amine group and a combination thereof. R₁ may be an aliphatic group, an aromatic group, or a combination thereof.

The copolymer may further comprise F. F may be selected from the group consisting of an antioxidant, a metal passivator, an end capping agent, a nucleating agent, an acid scavenger, a heat stabilizer, a UV stabilizer, a lubricant plasticizer, a crosslinking agent, and a combination thereof.

An antioxidant may be selected from the group consisting of BASF Irganox 168, 101, 245, 1024, 1076, 1098, 3114, MD 1024, 1025, ADEKA AO-60, 80, STAB PEP-36, 8T, Albemarle AT-10, 245, 330, 626, 702, 733, 816, 1135 a combination thereof.

The copolymer may comprise a metal passivator no more than about 0.5 wt %, 1 wt % or 2 wt % of the copolymer. The metal passivator may be selected from the group consisting of BASF Chel-180, Eastman OABH, Naugard XL-1, MD24, ADEKA STAB CDA-1, 6, oxalic acid derivatives, hydrazines, salicylic acid derivatives, benzotriazole and guanidine compounds, and a combination thereof.

An end capping agent may be monofunctional organic alcohol, acid, amine or ester. The end capping agent may also be an isocynate, siloxane, isocyanate, chloride group, oxazolyl compound, oxazoline compound, anhydride compound or epoxy compound.

A nucleating agent may be inorganic salt or organic salt, talc, calcium oxide, carbon black, calcium carbonate, mica, sodium succinate, glutarate, sodium hexanoate, sodium 4-methylvalerate, adipates, aluminum p-tert-butylbenzoate (Al-PTB-BA), metal carboxylates (e.g., potassium benzoate, lithium benzoate, sodium cinnamate, sodium β-naphthoate), dibenzylidene sorbitol (DBS) derivatives (di(p-methylbenzylidene) sorbitol (P-M-DBS), di(p-chlorobenzylidene) sorbitol (P-CI-DBS)). Commercial examples include SURLYN 9020, SURLYN1601, SURLYN1605, SURLYN1650, SURLYN1652, SURLYN1702, SURLYN1705, SURLYN8920, SURLYN8940, SURLYNPC-350 and SURLYNPC-2000.

An acid scavenger may be metal stearate or lactate such as calcium stearate or calcium lactate, or an inorganic substance such as hydrotalcite, zinc oxide, magnesium oxide or aluminum oxide.

A heat stabilizer may be an amine compound, phenol compound, thioester compound, phosphite compound or benzofuraone compound. The heat stabilizer may also be a lead salt heat stabilizer (e.g., tribasic lead sulfate, dibasic lead phosphite, dibasic lead stearate or basic lead carbonate), a metal soap heat stabilizer (e.g., zinc stearate, stearic acid, calcium or magnesium stearate), an organotin heat stabilizer (e.g., sulfur-containing organotins or organotin carboxylates) or a rare earth heat stabilizer.

A UV stabilizer may be a triazine compound, benzotriazole compound, benzophenone compound, salicylic acid ester compound or acrylonitrile compound. Examples of UV stabilizers include:

UV 944, CAS #: 70624-18-9, Poly[[6-[(1,1,3,3-tetramethylbutyl)amino]-1,3,5-triazine-2,4-diyl][(2,2,6,6-tetramethyl-4-piperidinyl)imino]-1,6-hexanediyl[(2,2,6,6-tetramethyl-4-piperidinyl)imino]],

UV770, CAS #52829-07-9, Bis(2,2,6,6,-tetramethyl-4-piperidyl)sebaceate,

UV622, CAS #65447-77-0, Butanedioic acid, dimethylester, polymer with 4-hydroxy-2,2,6,6-tetramethyl-1-piperidine ethanol,

UV783, a half-half mixture of UV622 and UV944,

UV531, CAS #1843-05-6, 2-benzoyl-5-(octyloxy) phenol,

UV326, CAS #3896-11-5, 2-(2′-Hydroxy-3′-t-butyl-5′-methylphenyl)-5-chlorobenzotriazole,

UV327, CAS #3864-99-1, 2-(2′-Hydroxy-3′, 5′-di-tert-butylphenyl)-5-chlorobenzotriazole,

UV292, a mixture of Bis(1,2,2,6,6-pentamethyl-4-piperidinyl)sebacate, CAS #41556-26-7 (75-85%) and Methyl(1,2,2,6,6-pentamethyl-4-piperidinyl)sebacate, CAS #82919-37-7 (15-25%) and,

UV123 CAS #129757-67-1, Bis(1-octyloxy-2,2,6,6-tetramethyl-4-piperidyl)sebacate.

A lubricant plasticizer may be a saturated hydrocarbon (e.g., solid paraffin, liquid paraffin, microcrystalline paraffin or low molecular weight polyethylene), a metal stearate (e.g., zinc stearate, calcium stearate or magnesium stearate), an aliphatic amide (e.g., ethylene bis stearamide (EBS) or oleamide), a fatty acid (e.g., stearic acid or hydroxystearic acid), a fatty acid ester (e.g., pentaerythrityl tetrastearate (PETS), glyceryl monostearate or glyceryl polystearate) and a fatty alcohol (e.g., stearyl alcohol or pentaerythritol).

A crosslinking agent may be selected from the group consisting of isocyanates (e.g., emulsifiable methylene diphenyl diisocyanate (MDI), tetraisocyanate, triisocyanate, polyisocyanate (e.g., Leiknonat JQ glue series, and Desmodur L series)), acrylates (e.g., 1,4-butanediol diacrylate, ethylene glycol dimethacrylate and butyl acrylate), organic peroxides (e.g., dicumyl peroxide, benzoyl peroxide, and di-tert-butyl peroxide), polyols, polybasic acids or polyamines (e.g., hexahydrophthalic anhydride, triethylenetetramine, dimethylaminopropylamine, diethylaminopropylamine, propylenediamine, polyethylene glycol, polypropylene glycol and trimethylolpropane).

For each copolymer of the present invention, a process for preparing the copolymer is provided. The process comprises ring-opening polymerizing glycolide in a molten state, and extruding and granulating the resulting polyglycolide, also known as poly (glycolic acid) (PGA). The polyglycolide may be extruded and granulated with an additive selected from the group consisting of E, F or a combination thereof. The process may further comprise feeding the polyglycolide into an extruder, into which the E and the F are added.

The ring-opening polymerization of glycolide may be a three-stage reaction.

In the first stage, glycolide may be reacted with a ring-opening polymerization catalyst at a temperature of about 60-180° C., preferably about 80-160° C., for no more than about 150 minutes, preferably not more than about 120 minutes. The glycolide may be mixed with the catalyst uniformly. This first stage may be carried out in a reactor.

The ring-opening polymerization catalyst may be a metal catalyst or a non-metal catalyst. The catalyst may be selected from the group consisting of a rare earth element, a rare earth element oxide, a metal magnesium compound, an alkali metal chelate compound (e.g., tin, antimony, or titanium), a metal ruthenium and a combination thereof. The catalyst may be about 0.01-5 wt %, preferably about 0.1-5 wt %, more preferably about 1-3 wt %, of the glycolide.

In the second stage, the mixture from the first stage may be maintained at a temperature of about 100-200° C., preferably about 120-280° C., for a time from about 0.1 minute to about 90 hours, preferably from about 1 minute to about 72 hours. This second stage may be carried out in a plug flow reactor. The plug flow reactor may be a static mixer, a twin-screw unit, or a horizontal disk reactor. Where the plug flow reactor is a twin-screw unit, the second stage may be carried out at about 200-300° C., preferably about 230-280° C., more preferably about 240-270° C.

In the third stage, the mixture from the second stage may be maintained at a temperature of about 150-300° C., preferably about 160-280° C., and an absolute pressure no more than about 6,000, preferably no more than about 5,000 Pa, for a time from about 0.1 minute to about 36 hours, preferably from about 1 minute to about 24 hours. As a result, a polyglycolide is prepared. The third stage may be carried out in a devolatilization reactor.

The copolymer of the present invention may comprise an additive at about 0.01-5 wt %, preferably about 0.01-3 wt %, more preferably about 0.01-1 wt %, based on the total weight of the copolymer. The additive may be selected from the group consisting of E, F and a combination thereof.

The copolymer may have a weight-average molecular weight of 10,000-1,000,000. The copolymer may have a ratio of a weight-average molecular weight to a number-average molecular weight (Mw/Mn) at about 1-10, preferably about 1.2-8, more preferably about 1.5-5.

The copolymer may have a melt index (MFR) of about 0.1-1000 g/10 min, preferably about 0.15-500 g/10 min, more preferably about 0.2-100 g/10 min. The MFR of a copolymer may be determined using a MFR method. The MFR method comprises drying the copolymer under vacuum at about 100-110° C. (e.g., about 105° C.); packing the dried copolymer into a rod; keeping the rod at a temperature of about 220-240° C. (e.g., about 230° C.), for about 0.5-1.5 minutes (e.g., about 1.0 minute); cutting a segment from the rod about every 15-45 seconds (e.g., about every 30 seconds); and determining a MFR of each segment based on MFR=600 W/t (g/10 min). W is the average mass of each segment. t is the cutting time gap for each segment. About 3-5 g (e.g., 4 g) of the dried copolymer may be loaded into a barrel, a plunger may be inserted into the barrel to compact the dried copolymer into the rod, and a weight of 2-3 kg (e.g., 2.16 kg) may be placed on the top of the plunger.

The copolymer may be hydrolytic stable. At least about 50, 55, 60, 65, 66, 70, 75, 80, 85, 90, 95 or 99 wt % of the copolymer may remain at about 50, 55, 60, 65, 70 or 75° C. after 1, 2, 3, 4, 5, 6, 7, 8, 9, 10, 11, 12, 13 or 14 days.

The term “about” as used herein when referring to a measurable value such as an amount, a percentage, and the like, is meant to encompass variations of ±20% or ±10%, more preferably ±5%, even more preferably ±1%, and still more preferably ±0.1% from the specified value, as such variations are appropriate.

### Example 1. Polyglycolide (or Poly (Glycolic Acid) (PGA))

Glycolide and ring-opening polymerization catalyst tin dichloride dihydrate in an amount of 0.01 part by weight relative to the weight of the glycolide are mixed uniformly in a prefabricated tank reactor at 120° C. for 60 min.

The material in the prefabricated tank reactor is introduced into a polymerization reactor and reacted at 200° C. for 300 min under an absolute pressure of 0.1 MPa. The polymerization reactor is a plug flow reactor, which may be a static mixer, a twin-screw unit or a horizontal disk reaction.

The material in the polymerization reactor is introduced into an optimization reactor at a mixing speed of 200 RPM at 220° C., an absolute pressure of 50 Pa. The reaction time is 30 min. As a result, polyglycolide is prepared.

### Example 2. Characterization

1. Weight-Average Molecular Weight and its Distribution

A sample is dissolved in a solution of five mmol/L sodium trifluoroacetate in hexafluoroisopropanol to prepare a solution of 0.05-0.3 wt % (mass fraction). The solution is then filtered with a 0.4 μm pore size polytetrafluoroethylene filter. 20 μL of the filtered solution is added to the Gel permeation chromatography (GPC) injector for determination of molecular weight of the sample. Five standard molecular weights of methyl methacrylate with different molecular weights are used for molecular weight correction.

2. Tensile Strength Test

The tensile strength is tested according to GB/T1040 1-2006 and the tensile speed is 50 mm/min.

3. Melt Index (MFR) Test

The melt index (MFR) of a copolymer is tested according to the following: 1) drying the copolymer in a vacuum drying oven at 105° C.; 2) setting the test temperature of the test instrument to 230° C. and preheating the instrument; 3) loading 4 g of the dried copolymer into a barrel through a funnel and inserting a plunger into the barrel to compact the dried copolymer into a rod; 4) keeping the dried copolymer in the rod for 1 min with a weight of 2.16 kg pressing on top of the rod, and then cutting a segment every 30s to obtain a total of five segments; 5) weighing the mass of each sample and calculating its MFR. MFR=600 W/t (g/10 min), where W is the average mass per segment of the sample and t is the cutting time gap for each segment.

4. Degradation Performance Test

5 g of a sample strip of a copolymer is subject to oscillating degradation (60 r/min) in 250 ml of deionized water at 65° C. After 7 days, samples are taken and dried under vacuum at 30° C. to constant weight. The residual mass is measured.

### Example 3. Copolymers

A polyglycolide (PGA), copolymers 1-6 and a comparative polylactic acid (PLA) were prepared with the polyglycolide as described in Example 1 and one or more additives, and then characterized according to the methods described in Example 2. Table 1 shows the compositions and properties of these copolymers.

PGA was prepared by placing the polyglycolide and additives 0.06 wt % Irganox 168 and 0.03 wt % Irganox MD-1025, based on the total weight of the copolymer, in a twin-screw extruder for granulation into particles at an extrusion temperature of 250° C. The particles were dried at 120° C. for 4 hours and molded into stripes for testing using an injection-molding machine at an injection temperature of 250° C. and a molding temperature of 100° C. The testing results are shown in Table 1.

Copolymer 1 was prepared by placing the polyglycolide and additives 0.06 wt % Irganox 168, 0.03 wt % Irganox MD-1025 and 0.2 wt % of ADR4368, based on the total weight of the copolymer, in a twin-screw extruder for granulation into particles at an extrusion temperature of 250° C. The particles were dried at 120° C. for 4 hours and molded into stripes for testing using an injection-molding machine at an injection temperature of 250° C. and a molding temperature of 100° C. The test results are shown in Table 1.

Copolymer 2 was prepared by placing the polyglycolide and additives 0.06 wt % Irganox 168, 0.03 wt % Irganox MD-1025 and 0.2% of ECN1299, based on the total weight of the copolymer, in a twin-screw extruder for granulation into particles at an extrusion temperature of 250° C. The particles were dried at 120° C. for 4 hours and molded into stripes for testing using an injection-molding machine at an injection temperature of 250° C. and a molding temperature of 100° C. The testing results are shown in Table 1.

Copolymer 3 was prepared by placing the polyglycolide and additives 0.06 wt % Irganox 168, 0.05 wt % Eastman OABH and 0.3 wt % EPOCROS RPS1005, based on the total weight of the copolymer, in a twin-screw extruder for granulation into particles at an extrusion temperature of 250° C. The particles were dried at 120° C. for 4 hours and molded into stripes for testing using an injection-molding machine at an injection temperature of 250° C. and a molding temperature of 100° C. The testing results are shown in Table 1.

Copolymer 4 was prepared by placing the polyglycolide and additives 0.06 wt % STAB PEP-36, 0.06 wt % Naugard XL-1 and 0.3 wt % ADR4368, based on the total weight of the copolymer, in a twin-screw extruder for granulation into particles at an extrusion temperature of 250° C. The particles were dried at 120° C. for 4 hours and molded into stripes for testing using an injection-molding machine at an injection temperature of 250° C. and a molding temperature of 100° C. The testing results are shown in Table 1.

Copolymer 5 was prepared by placing the polyglycolide and additives 0.06 wt % STAB PEP-36, 0.06 wt % Chel-180 and 0.5 wt % ECN1299, based on the total weight of the copolymer, in a twin-screw extruder for granulation into particles at an extrusion temperature of 250° C. The particles were dried at 120° C. for 4 hours and molded into stripes for testing using an injection-molding machine at an injection temperature of 250° C. and a molding temperature of 100° C. The testing results are shown in Table 1.

Copolymer 6 was prepared by placing the polyglycolide and additives 0.03 wt % STAB PEP-36, 0.05 wt % Irganox MD-1025 and 1 wt % EPOCROS RPS1005, based on the total weight of the copolymer, in a twin-screw extruder for granulation into particles at an extrusion temperature of 250° C. The particles were dried at 120° C. for 4 hours and molded into stripes for testing using an injection-molding machine at an injection temperature of 250° C. and a molding temperature of 100° C. The testing results are shown in Table 1.

Comparative copolymer was prepared by placing polylactic acid (PLA) prepared according the process described in Example 1 and additive 0.06 wt % of Irganox 168 was added, and then characterized according to the methods described in Example 2. Table 1 shows the compositions and properties of the comparative copolymer.

In general, polyglycolide degrades after being processed by an extruder. The MFR of the particles after extrusion granulation reflects the thermal stability of the polymer melt. The higher the MFR is after granulation, the worse the thermal stability of the melt is. The MFR of the PGA was 58 g/10 min. As compared to the PGA, Copolymers 1 and 2 contained additional ADR4368 and ECN1299, respectively, their MFRs were significantly lowered, indicating that the resulting PGA copolymers were less degraded and had higher thermal stability. Similarly, as compared to the PGA, Copolymers 3-6 contained structural modifiers ADR4368, ECN1299, and EPOCROS RPS1005 in addition to different antioxidants and metal passivators showed reduced MFR values and increased thermal stability. By comparison among Copolymers 1-6, it was found that after the formation of the polyglycolide copolymer, the tensile modulus thereof increased, indicating that the mechanical properties were enhanced, and the residual amount increased after the hydrolysis test at 65° C., indicating that the copolymer had higher hydrolytic stability. Compared to the Comparative Copolymer, Copolymers 1-6 showed greater tensile modulus, indicating that polyglycolide and copolymers thereof have better mechanical properties than comparative polylactic acid.

TABLE 1
Polymer Synthesis Parameters and Performance Results

| | Unit | PGA | Copolymer 1 | Copolymer 2 | Copolymer 3 | Copolymer 4 | Copolymer 5 | Copolymer 6 | PLA |
|---|---|---|---|---|---|---|---|---|---|
| Polymer in | % | 99.91 | 99.71 | 99.71 | 99.59 | 99.58 | 99.38 | 99.42 | |
| Reactor | | | | | | | | | |
| PLA | % | | | | | | | | 99.94 |
| Irganox 168 | % | 0.06 | 0.06 | 0.06 | 0.06 | | | | 0.06 |
| STAB PEP-36 | % | | | | | 0.06 | 0.06 | 0.03 | |
| Irganox MD- | % | 0.03 | 0.03 | 0.03 | | | | 0.05 | |
| 1025 | | | | | | | | | |
| Eastman OABH | % | | | | 0.05 | | | | |
| Naugard XL-1 | % | | | | | 0.06 | | | |
| Chel-180 | % | | | | | | 0.06 | | |
| ADR4368 | % | | 0.2 | | | 0.3 | | | |
| ECN1299 | % | | | 0.2 | | | 0.5 | | |
| EPOCROS RPS1005 | % | | | | 0.3 | | | 1 | |
| MFR | g/10 min | 58 | 42 | 43 | 39 | 35 | 34 | 27 | 22 |
| Mw | g/mol | 84500 | 109000 | 100490 | 112000 | 132700 | 134600 | 146700 | 157900 |
| Tensile modulus | Mpa | 5838 | 6077 | 6010 | 6115 | 6199 | 6187 | 6301 | 2436 |
| Tensile stress | Mpa | 114 | 113 | 114 | 112 | 115 | 118 | 118 | 49.5 |
| Tensile | % | 10.1 | 16 | 12.7 | 17.4 | 13.1 | 20.1 | 10.3 | 3.5 |
| enlongation | | | | | | | | | |
| Degradation | | 66 | 80 | 79 | 83 | 86 | 87 | 90 | 99 |
| Test (65° C., | | | | | | | | | |
| remaining mass | | | | | | | | | |
| after 7 days)% | | | | | | | | | |

Although the invention is illustrated and described herein with reference to specific embodiments, the invention is not intended to be limited to the details shown. Rather, various modifications may be made in the details within the scope and range of equivalents of the claims without departing from the invention.

1. A copolymer comprising one or more repeating units of C-(Aₓ-B_{y})ₙ-D, wherein:
A is 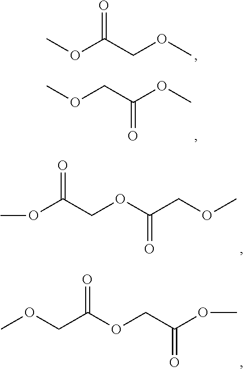
or a combination thereof;
B is G-R₁—W;
G and W are each selected from the group consisting of —CO—NH—, —CO—R₂—CO—OH, —CO—, —(CH₂)₂NH—CO—, —CH₂—CH(OH)—CH₂— and —NH;
R₁ is an aliphatic polymer, an aromatic polymer or a combination thereof;
R₂ is an alkyl group, an aromatic group, or an olefin group;
x is between 1 and 1500;
y is between 1 and 1500;
n is between 1 and 10000;
C and D are each a terminal group selected from the group consisting of a hydroxyl group, a carboxyl group, an amine group, an alkyl group, an aromatic group, an ether group, an alkene group, a halogenated hydrocarbon group and a combination thereof; and
A and B are different in structure.

2. The copolymer of claim 1, further comprising an additive selected from the group consisting of E, F and a combination thereof,
wherein E is one or more of units of i and j are each selected from the group consisting of an isocyanate group (—N═C═O), an acid chloride group, an oxazolyl group, an oxazoline group, an anhydride, an epoxy group, an amine group and a combination thereof; and R₁ is an aliphatic group, an aromatic group, or a combination thereof; and
wherein F is selected from the group consisting of an antioxidant, a metal passivator, an end capping agent, a nucleating agent, an acid scavenger, a heat stabilizer, a UV stabilizer, a lubricant plasticizer, a crosslinking agent, and a combination thereof.

3. A process for preparing a copolymer, comprising
(a) ring-opening polymerizing glycolide in a molten state, whereby a polyglycolide is formed; and
(b) extruding and granulating the polyglycolide, whereby a copolymer is prepared, wherein the copolymer comprises one or more repeating units of C-(Aₓ-B_{y})ₙ-D:
A is 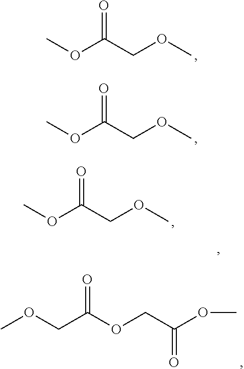
or a combination thereof;
B is G-R₁—W;
G and W are each selected from the group consisting of —CO—NH—, —CO—R₂—CO—OH, —CO—, —(CH₂)₂NH—CO—, —CH₂—CH(OH)—CH₂— and —NH;
R₁ is an aliphatic polymer, an aromatic polymer or a combination thereof;
R₂ is an alkyl group, an aromatic group, or an olefin group;
x is between 1 and 1,500;
y is between 1 and 1,500;
n is between 1 and 10,000;
C and D are each a terminal group selected from the group consisting of a hydroxyl group, a carboxyl group, an amine group, an alkyl group, an aromatic group, an ether group, an alkene group, a halogenated hydrocarbon group and a combination thereof;
A and B are different in structure.

4. The process of claim 3, wherein the polyglycolide is extruded and granulated with an additive selected from the group consisting of E, F or a combination thereof,
wherein E is one or more of units of i-R₁-j; i and j are each selected from the group consisting of an isocyanate group (—N═C═O), an acid chloride group, an oxazolyl group, an oxazoline group, an anhydride, an epoxy group, an amine group and a combination thereof; R₁ is an aliphatic group, an aromatic group, or a combination thereof; and
wherein F is selected from the group consisting of an antioxidant, a metal passivator, an end capping agent, a nucleating agent, an acid scavenger, a heat stabilizer, a UV stabilizer, a lubricant plasticizer, a crosslinking agent, and a combination thereof.

5. The process of claim 4, further comprising feeding the polyglycolide into an extruder, and adding the additive into the extruder.

6. The process of claim 3, wherein step (a) is a three-stage reaction comprising:
(a) reacting the glycolide with a ring-opening polymerization catalyst at 80-160° C. for no more than 120 minutes, wherein a first mixture is formed;
(b) maintaining the first mixture at 120-280° C. for a time from 1 minute to 72 hours, whereby a second mixture is formed;
(c) maintaining the second mixture at 160-280° C. and an absolute pressure no more than 5000 Pa for a time from 1 minute to 24 hours, whereby the polyglycolide is formed.

7. The process of claim 6, wherein the ring-opening polymerization catalyst is a metal catalyst.

8. The process of claim 6, wherein the ring-opening polymerization catalyst is a non-metal catalyst.

9. The process of claim 6, wherein the ring-opening polymerization catalyst is selected from the group consisting of a rare earth element, a rare earth element oxide, a metal magnesium compound, an alkali metal chelate compound, a metal ruthenium and a combination thereof.

10. The process of claim 6, wherein the catalyst is 0.01-5 wt % of the glycolide.

11. The process of claim 6, wherein step (a) further comprising mixing the glycolide with the ring-opening polymerization catalyst uniformly.

12. The process of claim 6, wherein step (a) is carried out in a reactor.

13. The process of claim 6, wherein step (b) is carried out in a plug flow reactor.

14. The process of claim 13, wherein the plug flow reactor is selected from the group consisting of a static mixer, a twin-screw unit and a horizontal disk reactor.

15. The process of claim 6, wherein step (c) is carried out in a devolatilization reactor.

16. The process of claim 3, wherein step (b) is carried out in a twin-screw extruder at 200-300° C.

17. A copolymer prepared according to the process of claim 3.

18. The copolymer of claim 2, wherein the copolymer comprises the additive at 0.01-5 wt %, based on the total weight of the copolymer.

19. The copolymer of claim 1, wherein the copolymer has a weight-average molecular weight of 10,000-1,000,000.

20. The copolymer of claim 1, wherein the copolymer has a ratio of a weight-average molecular weight to a number-average molecular weight (Mw/Mn) of 1-10.

21. The copolymer of claim 1, wherein the copolymer has a melt index (MFR) of 0.1-1000 g/10 min.

22. The copolymer of claim 21, wherein the melt index (MFR) is determined according to a method comprising:
(a) drying the copolymer under vacuum at 100-110° C.;
(b) packing the dried copolymer from step (a) into a rod;
(c) keeping the rod at 220-240° C. for 0.5-1.5 minutes;
(d) cutting a segment from the rod every 15-45 seconds after step (c); and
(e) determining a MFR of each segment based on MFR=600 W/t (g/10 min), wherein W is the average mass of each segment and t is the cutting time gap for each segment.

23. The copolymer of claim 22, wherein step (b) further comprises loading 3-5 g of the dried copolymer into a barrel, inserting a plunger into the barrel to compact the dried copolymer into the rod, and placing a weight of 2-3 kg on the top of the plunger.

24. The copolymer of claim 1, wherein at least 66 wt % of the copolymer remains after 7 days at 65° C.
